(19) United States
(12) Patent Application Publication
(10) Pub. No.: US 2006/0294412 A1
(43) Pub. Date: Dec. 28, 2006

(54) System and method for prioritizing disk access for shared-disk applications

(75) Inventors: Mahmoud B. Ahmadian, Pflugerville, TX (US); Ujjwal Rajbhandari, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/167,439

(22) Filed: Jun. 27, 2005

(51) Int. Cl. G06F 11/00

(52) U.S. Cl. 714/4

(57) ABSTRACT

A system and method for prioritizing disk access for a shared-disk storage system are disclosed. The system includes a cluster of computing systems coupled via a network, wherein the cluster of computing systems includes at least two nodes. A storage system is coupled to the network. The at least two nodes each may access the storage system. A high-priority buffer stores requests from the cluster of computing systems for high-priority information stored in the storage system, and a low-priority buffer stores requests from the cluster of computing systems for low-priority information stored in the storage system. A storage-system controller serves requests stored in the high-priority buffer before serving requests stored in the low-priority buffer.

### TECHNICAL FIELD

The present disclosure relates generally to computer systems and information handling systems, and, more specifically, to a system and method for prioritizing disk access for shared-disk applications.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Cluster database software can allow a collection, or “cluster,” of networked computing systems, or “nodes,” shared access to a single database. One example of cluster database software is the Real Application Cluster software of Oracle Corporation in Redwood Shores, Calif. The shared database may be located in a set of shared storage devices, such as a shared set of external disks. Although this shared-access feature offers many advantages, problems may arise if every node in the cluster attempts to access the shared external disks simultaneously. The resulting disk-access contentions could lead to timeout failures for the requested I/O operations. The extra time needed to retry failed I/O operations may put the operation of the cluster as a whole at risk. For example, the cluster database may designate one or more disks, or one or more partitions, in the shared external disks as a “voting disk,” which stores and provides cluster-status information. Timely access to the voting disk by the nodes is critical to the continued operation of the cluster. If the nodes cannot access the voting disk before the set timeout period for operations expires, certain processes performed by the cluster could fail.

### SUMMARY

A system and method for prioritizing disk access for a shared-disk storage system are disclosed. The system includes a cluster of computing systems coupled via a network, wherein the cluster of computing systems includes at least two nodes. A storage system is coupled to the network. The at least two nodes each may access the storage system. A high-priority buffer stores requests from the cluster of computing systems for high-priority information stored in the storage system, and a low-priority buffer stores requests from the cluster of computing systems for low-priority information stored in the storage system. A storage-system controller serves requests stored in the high-priority buffer before serving requests stored in the low-priority buffer.

The system and method disclosed herein are technically advantageous because they reduce the chances of timeout failures for I/O requests for critical information by allowing the cluster to serve requests for high-priority information before serving requests for low-priority information. Timeout failures can force the requesting node to reboot. Any other services performed by the rebooting node will be delayed until the reboot is complete, ultimately slowing the operation of the cluster of computing systems. Moreover, because timeout failures for critical I/O requests can lead to the failure of the entire cluster of computing systems in certain situations, the resulting reduction in timeout failures for critical requests improves the stability of the cluster as a whole.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of hardware and software elements of an example cluster database system;

FIG. 2 is a block diagram of hardware and software elements of an example shared-disk storage system;

FIG. 3 is a block diagram of hardware and software elements of an example shared-disk storage system; and

FIG. 4 is a flow diagram of an example method of prioritizing disk access for shared-disk applications.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

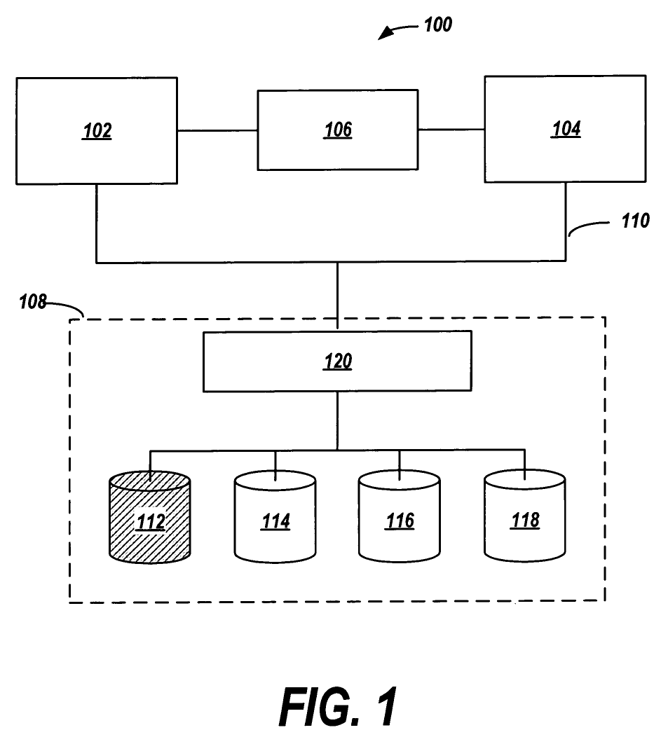

FIG. 1 illustrates an example cluster database system 100 that includes two nodes 102 and 104. Although the example cluster database system 100 shown in FIG. 1 includes only two nodes, cluster database systems may include additional nodes, if necessary. Nodes 102 and 104 each may include a central processing component, at least one memory component, and a storage component, not shown in FIG. 1. Nodes 102 and 104 may be linked by a high-speed operating-system-dependent transport component 106, sometimes known as an interprocess communication (“IPC”) or “interconnect.” Interconnect 106 acts as a resource coordinator for nodes 102 and 104 by routing internode communications and other cluster communications traffic. Interconnect 106 may define the protocols and interfaces required for such communications. As persons of ordinary skill in the art having the benefit of this disclosure will realize, the hardware used in interconnect 106 may include Ethernet, a Fiber Distributed Data Interface, or other proprietary hardware, depending on the architecture for the cluster.

As shown in FIG. 1, cluster database system 100 may include a shared-disk storage system 108. Nodes 102 and 104 may be coupled to shared-disk storage system 108 via a storage-area network 110 such that the nodes can access the data in shared-disk storage system 108 simultaneously. Through storage-area network 110, notes 102 and 104 also may have uniform access to the data in shared-disk storage system 108. The components of shared-disk storage system 108 may vary depending on the operating system used in cluster database system; a cluster file system may be appropriate for some cluster database system 100 configurations, but raw storage devices may also be used. The example shared-disk storage system 108 depicted in FIG. 1 includes four disks, labeled 112, 114, 116, and 118, respectively. As persons of ordinary skill in the art having the benefit of this disclosure will realize, however, shared-disk storage system 108 may include more or fewer disks, as needed. Disks 112, 114, 116, and 118 could be any type of rewritable storage device such as a hard drive; use of the term “disk” or “disks” should not be restricted to “disk” or “disks” in the literal sense.

Example shared-disk storage system 108 may use a Redundant Array of Independent Disks (“RAID”) configuration to guard against data loss should any of the individual shared-disks 112, 114, 116, or 118 fail. As such, cluster database system 100 may include a storage-system controller 120 to handle the management of disks 112, 114, 116, and 118. Storage-system controller 120 may perform any parity calculations that may be required to maintain the selected RAID configuration. Storage-system controller 120 may consist of software and, in some cases, hardware, components located in ones of the nodes 102 or 104. Alternatively, storage-system controller 120 may reside within example shared-disk storage system 108, if desired. Shared-disk storage system 108 may be configured according to any RAID Level desired or may use an alternative redundant storage methodology. Also, shared-disk storage system 108 may be configured in a software-based RAID system that does not rely on storage-system controller 120 but instead upon a host-based volume manager for management commands and parity calculations.

Typically, storage-system controller 120 will treat requests for data from the different disks 112, 114, 116, and 118, equally and will process such requests in the order that they were received. Thus, a request for data located in disk 112 will be given equal weight as a request for data located in storage device 114, even if disk 112 contains data that is critical to the continued operation of cluster 100, while disk 114 contains only non-critical data. This equal treatment may cause problematic disk-access contentions. For example, the cluster database software may designate one disk as the voting disk, such as disc 112 in shared-disk storage system 108. Again, the voting disk will contain information, such as cluster-status information, that is critical to the continued function of the database. Should node 102 send a request for non-critical information stored on disk 114 and then node 104 send a request for critical information from disk 112, Storage-system controller 120 will queue the requests in the order received.

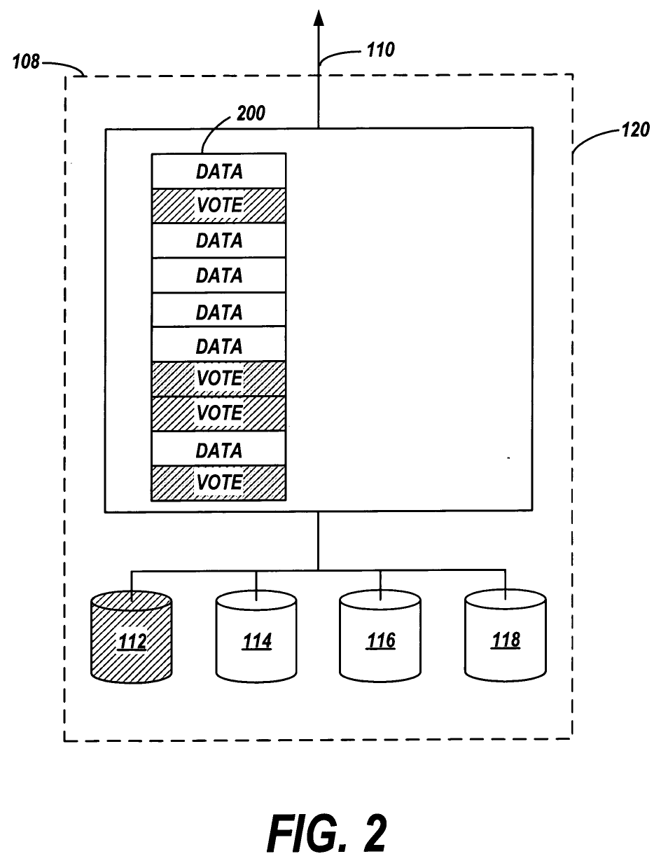

FIG. 2 provides a schematic illustration of shared-disk storage system 108 with a figurative request buffer 200 experiencing such a backlog: requests for critical information from the OCR/voting disk stored on disk 112, shaded in FIG. 2, are interspersed with requests for non-critical data stored on other disks. If storage-system controller 120 cannot address the backlog in time, request such as that by node 104 may be delayed beyond the set timeout period expires. Again, timely access to the voting disk by the nodes is critical to the continued operation of the cluster. The delays caused by the bottleneck at the storage-system controller 120 could lead to the failure certain critical processes performed by the cluster. The cluster member initiating this process, here node 104, would need to reboot. Any other processes node 104 was performing, such as file serving, a backup job, or systems monitoring, would be interrupted and need restarting upon rebooting.

In certain embodiments of the system and method of the present invention, disks in shared-disk storage system 108 may be assigned a priority level based on the information stored on the disk. A disk containing critical information, such as the voting disk, could be assigned a higher priority level than disks containing non-critical information. All I/O requests would be queued in a high-priority buffer or a low-priority buffer according to information they seek. Priority assignments could be made at the time the RAID system is created.

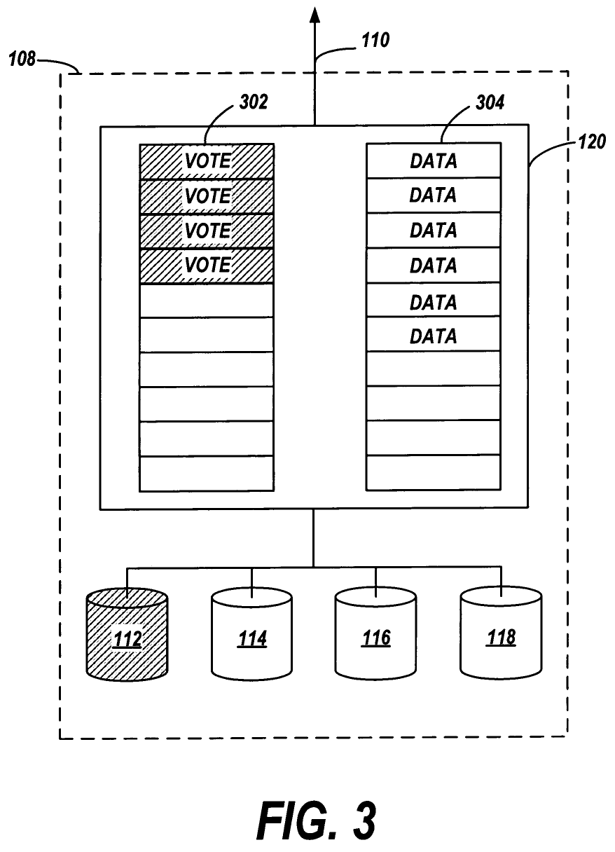

FIG. 3 schematically illustrates an example shared-disk storage system 108 with a figurative high-priority buffer 302 and a figurative low-priority buffer 304. Requests for critical information in disk 112, which stores the voting disk information, would be placed in high-priority buffer 302. Requests for non-critical data, such as the data stored in disk 114, would be placed in low-priority buffer 304. Although FIG. 3 illustrates only two buffers, additional buffers may be used to more finely separate I/O requests by priority.

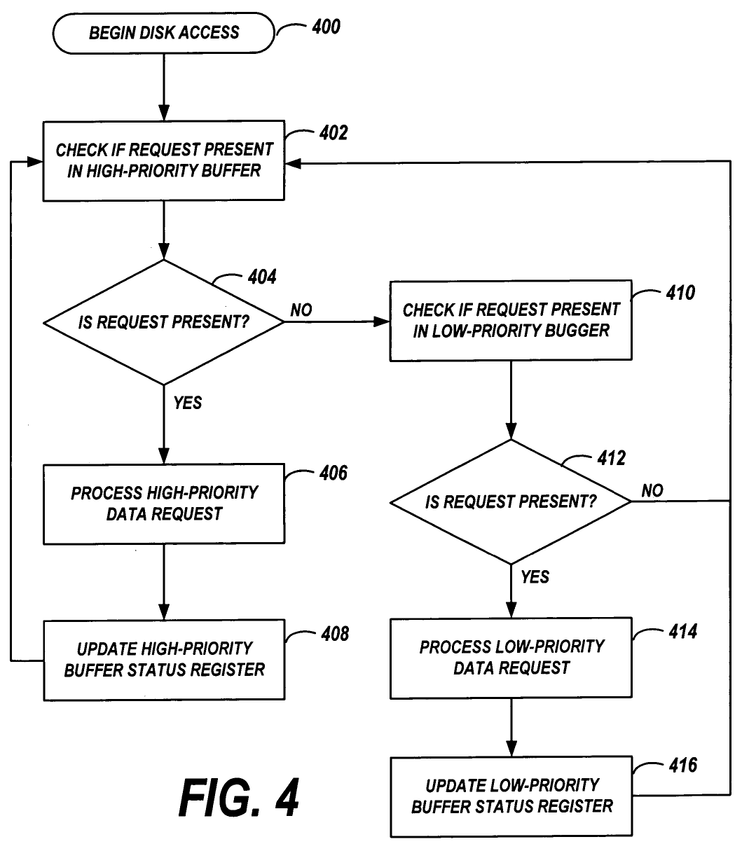

FIG. 4 shows a flow diagram of one embodiment of a method for prioritizing disk access for the shared-disk applications. Storage-system controller 120, or any other element of cluster database 100 that may be responsible for managing requests for information stored in shared-disk storage system 108, may first check the high-priority buffer to see if any I/O requests are pending, as shown in block 402. For the example shared-disk storage system 108 depicted in FIG. 3, storage-system controller 120 may check high-priority buffer 302. Storage-system controller 120 may then decide whether any requests are present in the high-priority buffer, as shown in block 404. This operation to check the status of high-priority buffer 302 can be accomplished quickly if regularly updated buffer status registers are employed. Performing two register “AND” operations will be sufficient to check the buffer status register. A buffer status register can be used to check if a buffer is currently being updated, as indicated by bits 0 through 15, with logic TRUE and where bit 0 always represents the highest-priority buffer. The use of buffer status registers can ensure the atomicity of update operations because as requests are processed, the buffer status register may be updated using the same method, as discussed later in this disclosure.

If data is present in the high-priority buffer, storage-system controller 120 may then move on to the step shown in block 406 and process a high-priority request or data block in the high-priority buffer. As shown by the arrows in FIG. 4, storage-system controller 120 then may repeat the steps shown in blocks 402, 404, and 406 and serve all pending I/O requests in high-priority buffer 302 until that buffer is empty. Once requests in the buffer have been updated or served, the buffer status registry for high-priority buffer 302 should be updated as well, as shown in block 408. Storage-system controller 120 may again return to the steps shown in block 402 and 404. If no data is present in high-priority buffer 302, storage-system controller 120 may address any requests in the next highest-priority buffer, which is low-priority buffer 304 for the example shared-disk storage system 108 shown in FIG. 3. To that end, storage-system controller 120 would check low-priority buffer 304 for data, as shown in block 410. As shown in block 412, storage-system controller 120 would determine whether any requests are present in low-priority buffer 304. If a request is present, storage-system controller 120 would process the request in low-priority data block 304, as shown in block 414. Once this step is complete, storage-system controller 120 may return to block 402 to begin the process anew. The buffer status registry for low-priority buffer 304 should be updated as storage-system controller 120 processes through the queued requests, as shown in block 416. Storage-system controller 120 may keep cycling through the flow diagram depicted in FIG. 4, constantly checking and rechecking the various buffers for the presence of data requests.

Although the present disclosure has described a shared-disk storage system with two buffers, a high-priority buffer and a low-priority buffer, the reader should recognize that the shared-disk storage system may incorporate any number of buffers of differing degrees of priority. That is, intermediate-priority buffers may be used between the low- and high-priority buffers, with requests in the intermediate-priority buffers served after requests in the high-priority buffer but before requests in the low-priority buffer. Moreover, the shared-disk storage system may use a less-rigid hierarchy for processing requests, if desired. For example, the shared-disk storage system may process higher-priority requests before lower-priority requests up and until a threshold number of lower-priority requests build up in the lower-priority buffers. At that point, the shared-disk storage system may service the lower-priority requests enough to bring the request total below the threshold before returning to processing the higher-priority requests. Although the present disclosure has been described in detail, it should be understood that various changes, substitutions, and alterations can be made hereto without departing from the spirit and the scope of the invention as defined by the appended claims.

What is claimed is:

1. A system for prioritizing disk access for a shared-disk storage system, comprising:
a cluster of computing systems coupled via a network, wherein the cluster of computing systems includes at least two nodes,
a storage system coupled to the network, wherein the at least two nodes each may access the storage system,
a high-priority buffer, wherein the high-priority buffer stores requests from the cluster of computing systems for high-priority information stored in the storage system,
a low-priority buffer, wherein the low-priority buffer stores requests from the cluster of computing systems for low-priority information stored in the storage system, and
a storage-system controller, wherein the storage-system controller serves requests stored in the high-priority buffer before serving requests stored in the low-priority buffer.

2. The system for prioritizing disk access for a shared-disk storage system of claim 1, further comprising:
a high-priority buffer status register, wherein the high-priority buffer status register contains an entry for each pending request for high-priority information stored in the high-priority buffer, and
a low-priority buffer status register, wherein the low-priority buffer status register contains an entry for each pending request for low-priority information stored in the low-priority buffer.

3. The system for prioritizing disk access for a shared-disk storage system of claim 1, further comprising at least one intermediate-priority buffer, wherein the storage-system controller serves requests stored in the intermediate-priority buffer after serving requests stored in the high-priority buffer but before serving requests stored in the low-priority buffer.

4. The system for prioritizing disk access for a shared-disk storage system of claim 3, further comprising an intermediate-priority buffer status register associated for each intermediate-priority buffer, wherein the intermediate-priority buffer status register contains an entry for each pending request for intermediate-priority information stored in the intermediate-priority buffer.

5. The system for prioritizing disk access for a shared-disk storage system of claim 1, further comprising a high-speed operating-system-dependent transport component that communicates with each of the at least two nodes via the network.

6. The system for prioritizing disk access for a shared-disk storage system of claim 1, wherein the storage system comprises at least two disks.

7. The system for prioritizing disk access for a shared-disk storage system of claim 6, wherein the at least two disks are configured to store data according to a redundant storage methodology.

8. The system for prioritizing disk access for a shared-disk storage system of claim 6, wherein one disk of the at least two disks is designated for storing cluster-status information.

9. The system for prioritizing disk access for a shared-disk storage system of claim 8, wherein requests for information from the disk designated for storing cluster-status information are considered high-priority requests.

10. A system for prioritizing disk access for a shared-disk storage system, comprising:
a cluster of computing systems coupled via a network, wherein the cluster of computing systems includes at least two nodes,
a storage system coupled to the network, wherein the at least two nodes each may access the storage system,
a high-priority buffer, wherein the high-priority buffer stores requests from the cluster of computing systems for high-priority information stored in the storage system,
a low-priority buffer, wherein the low-priority buffer stores requests from the cluster of computing systems for low-priority information stored in the storage system, and
a storage-system controller, wherein the storage-system controller serves requests stored in the high-priority buffer before serving requests stored in the low-priority buffer, unless a threshold number of low-priority requests are stored in the low-priority buffer.

11. The system for prioritizing disk access for a shared-disk storage system of claim 10 further comprising:
a high-priority buffer status register, wherein the high-priority buffer status register contains an entry for each pending request for high-priority information stored in the high-priority buffer, and
a low-priority buffer status register, wherein the low-priority buffer status register contains an entry for each pending request for low-priority information stored in the low-priority buffer.

12. A method for prioritizing disk access for a shared-disk storage system, comprising the steps of:
checking whether a high-priority buffer contains requests from at least one node in a cluster of computing systems for high-priority information stored in the shared-disk storage system,
processing a request for high-priority information, if present in the high-priority buffer, before processing requests stored in a low-priority buffer, if any.

13. The method for prioritizing disk access for a shared-disk storage system of claim 12, further comprising the steps of:
adding a registry entry to a high-priority buffer status register when a new request for high-priority information is added to the high-priority buffer, and
removing a registry entry from the high-priority buffer status register when a request for high-priority information in the high-priority buffer has been processed.

14. The method for prioritizing disk access for a shared-disk storage system of claim 13, wherein the step of checking whether the high-priority buffer contains requests comprises the step of performing two “AND” operations on the high-priority buffer status register.

15. The method for prioritizing disk access for a shared-disk storage system of claim 12, further comprising the steps of:
checking whether the low-priority buffer contains requests from the at least one node in the cluster of computing systems for low-priority information stored in the shared-disk storage system, if no requests are present in the high-priority buffer,
processing a request for low-priority information, if present in the low-priority buffer.

16. The method for prioritizing disk access for a shared-disk storage system of claim 15, further comprising the steps of:
adding a registry entry to a low-priority buffer status register when a new request for low-priority information is added to the low-priority buffer, and
removing a registry entry from the low-priority buffer status register when a request for low-priority information in the low-priority buffer has been processed.

17. The method for prioritizing disk access for a shared-disk storage system of claim 16, wherein the step of checking whether the high-priority buffer contains requests comprises the step of performing two “AND” operations on the high-priority buffer status register.

18. The method for prioritizing disk access for a shared-disk storage system of claim 12, further comprising the steps of:
checking whether an intermediate-priority buffer contains requests from the at least one node in the cluster of computing systems for intermediate-priority information stored in the shared-disk storage system, if no requests are present in the high-priority buffer,
processing a request for intermediate-priority information, if present in the intermediate-priority buffer, before processing requests stored in the low-priority buffer, if any.

19. The method for prioritizing disk access for a shared-disk storage system of claim 18, further comprising the steps of:
adding a registry entry to an intermediate-priority buffer status register when a new request for intermediate-priority information is added to the intermediate-priority buffer, and
removing a registry entry from the intermediate-priority buffer status register when a request for intermediate-priority information in the intermediate-priority buffer has been processed.

20. The method for prioritizing disk access for a shared-disk storage system of claim 19, wherein the step of checking whether the intermediate-priority buffer contains requests comprises the step of performing two “AND” operations on the intermediate-priority buffer status register.
